(19) United States
(12) Patent Application Publication
(10) Pub. No.: US 2017/0223993 A1
(43) Pub. Date: Aug. 10, 2017

(54) VEGETABLE-BASED SLICES FOR IMPROVED NUTRITION AND METHODS OF MAKING

(71) Applicant: Christopher Plummer, Dallas, TX (US)

(72) Inventor: Christopher Plummer, Dallas, TX (US)

(21) Appl. No.: 15/503,137

(22) PCT Filed: Aug. 5, 2015
(86) PCT No.: PCT/US15/43738

§ 371 Date: Feb. 10, 2017

Related U.S. Application Data
(60) Provisional application No. 62/035,680, filed on Aug. 11, 2014.
(60) Provisional application No. 62/040,293, filed on Aug. 21, 2014.

(51) Int. Cl. A23L 19/00; B33Y 80/00; A23P 30/00

(52) U.S. Cl. CPC A23L 19/09; A23P 30/00; B33Y 80/00

(57) ABSTRACT

The present invention offers an intentional use of a slice as a system for the deliberate delivery of vegetable or fruit servings. The slice comprises the use of whole vegetable powders, whole fruit powders or a combination thereof as a highly concentrated source of vegetable or fruit material. In addition, the formulation provides for desirable organoleptic properties which over-come the negative texture and flavor qualities generally associated with vegetable powders and or fruit powders.

### TECHNICAL FIELD OF THE INVENTION

The present invention relates generally to a fabricated foodstuff, more specifically to portioned, nutritious meal slices which can provide significant vegetable content. The present invention is an improvement over current sandwich or burger condiments by intentionally providing the high nutritive quality of vegetables while overcoming the reluctance of the consumer to include a significant quantity of vegetables to his overall diet. These slices may be applied to sandwiches, burgers and other dishes with enclosed condiments and ingredients, such as wraps, filled muffins, filled croissants, pitas, quesadillas, tacos, turnovers, filled pies, filled crepes or omelets; or open-faced items using sliced condiments such as pizzas, tostadas, casseroles (e.g., mac and cheese, quiche), stuffed potatoes or deviled eggs; i.e., any food items where the slice would be considered an appealing addition to the food item by the consumer. In this instance, the term “slice” implies a variety of shapes including, but not limited to, circular, oval, rectangular or other flat strips. In addition, the present invention also includes the provision of fruit servings as well as vegetable servings.

### BACKGROUND OF THE INVENTION

Nutritionists currently advocate for increased vegetable consumption to improve a person's diet for better overall health. For those who do not eat enough fresh vegetables, additional healthy options to supplement their daily diet would be beneficial. Vegetables are a source of phytonutrients, many of which have shown clinical improvement to health. For example, tomatoes contain lycopene, which is an antioxidant that may have an effect on reducing total cholesterol, LDL cholesterol and triglycerides as well as effects in thinning blood. Lycopene also may have anticancer effects.

Many consumers do not consume a healthy portion of vegetables because they find them unappealing for regular consumption. These consumers would be well-served by improvements to the texture and flavor of a foodstuff containing high vegetable content. The addition of condiments to burgers, sandwiches or other similar food is usually done to enhance flavor and improve the eating experience. Condiments include liquids (e.g., ketchup, BBQ sauce, mayonnaise), semi-solids (e.g., relish, salsa, marmalade, peanut butter), and solids (e.g., cheese slices, fresh and pickled vegetables). However, providing a significant amount of vegetable content (e.g., one full serving of vegetables) within such a condiment is challenging due to the high moisture content (˜90%) of raw vegetables.

Vegetable powders have been used as concentrated ingredients to boost vegetable content (approximately ten-fold over the raw vegetable based on equal weight amount of the vegetable powders versus the raw vegetables). However, in their inherent dry form, they tend to be unappealing and not easily consumed directly. Palatability of these vegetable powders can be improved when properly formulated with other ingredients such as carefully selected gums and fats which improve the mouthfeel of the overall product containing high vegetable content by increasing smoothness and reducing grittiness. The use of portioned slices simplifies the dispensing of large quantities of integrated vegetable powders in a convenient form. A slice with high vegetable content, appealing flavorings, and acceptable mouthfeel without grittiness would be a welcomed option for consumers. In addition, for the vegetarian market where vegetable use is well-accepted, these vegetable slices with appropriate flavorings could be used directly in larger quantities to easily boost vegetable or fruit serving levels even higher.

In addition to providing consumers a delivery of foodstuffs containing high vegetable content, as described in this application, our invention utilizes new methods of food processing and food production. This application also is directed to the application of our vegetable or fruit foodstuff formulation with “3D Printing” or “Additive Manufacturing”. 3D Printing and Additive Manufacturing are terms used to describe any of various processes for making three-dimensional objects using carefully selected materials such as related in this case to formulations and methods of preparation described herein, and including an electronic data source, which, using computerized controls, and primarily through additive processes in which successive layers of material are laid down, or by fixing shapes of matter using electronically guided fixatives such as alcohol, or by spraying, extruding or other deposition, are used to make the portioned nutritious meal slices (or other shapes) in the current invention.

Unlike the current conception of a slice for the delivery of vegetable servings, the concept of a slice for a molded condiment is not new. Sliced cheeses are available without any additional fabrication. In U.S. Pat. Nos. 6,759,069 (published Jul. 6, 2004) and 7,501,144 (published Mar. 10, 2009) a variety of geometric shapes are formed to allow portioning of condiments such as mayonnaise, relish, ketchup, marinades, creamers, sweeteners, etc. for sandwich or beverage application. Although the patent provides many details about the process of forming or molding different shapes, it only mentions briefly the chemistry or specific food ingredients which would allow the condiments to be aggregated (gelatin and egg are mentioned briefly in examples); nothing is mentioned about binding materials. In contrast to the current application, there is no mention of nutrition or the deliberate addition of vegetables and their role in enhancing nutrition. U.S. Pat. No. 6,632,468 (published Oct. 14, 2003) discusses cylinder, disc, slice, cube or shred shapes. They include a list of gelling agents which does not include the ingredient system in the preferred embodiment of the current invention (although they are on the list as “texturizing agents”). Ingredients include mainly thickened sauces and cocoa. Vegetable juices and concentrates, not purees or powders, are listed as flavor ingredients, but not as an intentional vegetable component for nutrition enhancement. The vegetable sources are from processed food ingredients, not whole vegetables, which are primarily used in the current invention.

Patent Application WO 201319936 A1 (published Feb. 7, 2013) covers a vegetable/fruit-based “leather” product to be consumed as a snack or mini-meal. Ingredient selection targets nutrition including a long list of vegetables (note that tomatoes are not on the list). The listing refers to whole vegetable, not powders or purees and considering the accompanying water content in whole, they are likely under the full serving for vegetable content per serving—whereas the current invention provides a full serving of vegetable per slice. Also the variety of final forms for the product—bar, cylinder, cube, star, prism, disc and combination—are seen as convenient handheld direct snack forms. No slice form is disclosed, nor does the reference teach any intention of using the product as a condiment or flavor supplement for another food item. A long list of fats is also included as a nutrient component without regard to functional physical characteristics (e.g., melting point).

Patent Application WO 2006010132 A3 (published Apr. 16,2009) involves the use of a food ingredient dispersed in a matrix consisting of xanthan gum and locust bean gum and optionally an edible oil. This gum combination does work well within the current invention presented here, but alternate gum systems have been used, and the preferred embodiment of the current invention uses a different system. The fat component (10-13%) of the current invention requires a much higher level than the claimed range for edible oil (1-5%) in this referenced patent application. It also mentions vegetable purees or sliced vegetables as possible components from a very wide selection of possible ingredients, but it does not specifically mention vegetable powders as a source, which is one of the innovations of the current invention to provide the high vegetable content. The reference discloses a specific example of using fresh tomato and tomato puree to make a tomato-based sliced product. The fresh tomato component in this example is 53.5% of the formulation, which actually strongly demonstrates the drastic differences achieved when using vegetable powders. Overall, the delivery of tomato solids would be about half of the vegetable content compared with the preferred embodiment of the current invention, with a much lower fraction of the formulation devoted to the vegetable component. In general, the current invention aims for a more palatable product for improved nutrition in general, but not the specific addition of high amounts of vegetable through a condiment form.

### DETAILED DESCRIPTIONS OF THE INVENTION

The present invention is described in detail herein, and it is disclosed in a manner that establishes a thorough understanding of it. Aspects of the invention may be practiced without the implementation of some of the described features. It should be understood that some details have not been discussed deeply in order to provide a clear focus of the invention.

The present invention offers an intentional use of a slice as a system for the deliberate delivery of vegetable servings. The slice comprises the use of whole vegetable powders and/or vegetable purées as a highly concentrated source of vegetable material. Vegetable powder is a term for vegetables (as listed elsewhere in this application) that have been dried using techniques such as freeze-drying, air-drying or various other de-hydration techniques and have then been ground into a powder. Vegetable puré (sometimes referred to as “mash”) is a term for vegetables (as listed elsewhere in this application) that have been ground, pressed, blended, and/or sieved to the consistency of a soft creamy paste or thick liquid. The present invention includes a product that delivers a serving of vegetables as these are understood in common parlance and commonly used in culinary practice, and including all the genera and families that we specify in our application, and including those plants, such as tomatoes and mushrooms, that may not be vegetables in scientific parlance but that are commonly understood to be, and used as, vegetables. In addition, another embodiment of the current invention is inclusive of fruit slices and fruit/vegetable slices in combination that can deliver at least a serving of fruit or fruit/vegetable combination in a slice with each slice providing the serving amount recommended by the Food and Drug Administration (FDA) and the US Department of Agriculture (USDA), in their respective capacities as regulatory bodies.

In addition, the formulation provides for desirable organoleptic properties which overcome the negative texture and flavor qualities generally associated with vegetable powders. Organoleptic properties are the aspects of food as experienced by the senses, including taste, sight and smell, the sensations in the mouth (also referred to as “Mouthfeel”) of touch, texture, dryness and moisture, and other sensations caused by food such as “pungency”, “spiciness” or “heat”. The specific organoleptic properties desired are smooth, non-gritty texture, firm enough to allow some chewing and to maintain the integrity of the slice, but with some melt of the product when external heat or heat in the mouth is applied while being consumed to release perceived juiciness, flavor and aroma. The appealing color and aroma of the slices and the popularly liked flavors of Catsup and BBQ are also important in this embodiment. Many different seasoning/flavoring systems are possible, as mentioned elsewhere.

Positive mouthfeel would include pleasing sensations in the mouth related to the following characteristics of the food: (a) Cohesiveness: Degree to which the food deforms before rupturing when biting with molars; (b) Density: Compactness of cross section of the food after biting completely through with the molars; (c) Dryness: Degree to which the food feels dry in the mouth; (d) Fracturability: Force with which the food crumbles, cracks or shatters. Fracturability encompasses crumbliness, crispiness, crunchiness and brittleness; (e) Graininess: Degree to which a food contains small grainy particles; (f) Gumminess: Energy required to disintegrate a semi-solid food to a state ready for swallowing; (g) Hardness: Force required to deform the food to given distance, i.e., force to compress between molars, bite through with incisors, compress between tongue and palate; (h) Heaviness: Weight of food perceived when first placed on tongue; (i) Moisture absorption: Amount of saliva absorbed by food; (j) Moisture release: Amount of wetness/juiciness released from food; (k) Mouthcoating: Type and degree of coating in the mouth after mastication (for example, fat/oil); (l) Roughness: Degree of abrasiveness of food's surface perceived by the tongue; (m) Slipperiness: Degree to which the food slides over the tongue; (n) Smoothness: Absence of any particles, lumps, bumps, etc., in the food; (o) Uniformity: Degree to which the food is even throughout; homogeneity; (p) Uniformity of Bite: Evenness of force through bite; (q) Uniformity of Chew: Degree to which the chewing characteristics of the food are even throughout mastication.

The present invention is a foodstuff which allows the addition of significant amounts of vegetable serving equivalents in a palatable form to enhance the eating quality. The preferred form is a slice for ease of use. Flavoring of the vegetable slices can include, but is not limited to condiment flavors (which might be more readily acceptable by consumers) such as Barbeque (BBQ) sauce or ketchup (catsup) and other mainstream flavors (e.g., relish, mushroom, chili, buffalo, etc.) or other more exotic flavors (e.g., teriyaki, Szechuan, hummus, curry, etc.).

The formulation of the product is at the heart of the invention. High vegetable content is required to provide the necessary high levels in the final product. In dried form, vegetable powders are unappealing due to solubility issues and negative mouthfeel, but they provide much more vegetable solids than fresh vegetables (approximately 10-fold based on relative weight due to moisture removal). Careful selection of ingredients, especially the gum and fat components, are essential to control the physical properties that lead to the resulting positively-perceived mouthfeel. The quantity and physical characteristics of the selected fat source is extremely important for the positive mouthfeel of the product, especially with respect to the product's firmness and its melting point characteristics. In addition to good organoleptic properties for consumption, the product also needs to be firm enough to withstand processing to create the easily deliverable slice form.

In the preferred embodiment of the invention, ingredients are grouped into the following categories: (1) Vegetable sources; (2) Dry ingredients (in addition to those in the vegetable sources); (3) Preservatives; (4) Binding agents; (5) Flavorings; and (6) Wet ingredients (in addition to those in the vegetable sources). The groupings assist in sorting ingredients for processing and to individually modify and optimize different aspects of the formulation including vegetable level and functional gelling agents. In an alternative embodiment, instead of vegetable sources, fruit sources or vegetable/fruit sources combined could be used.

Vegetable sources contain the “vegetable serving” portion of the formulation and is approximately 55-60% of the overall formula by weight. This portion contains both wet and dry types of ingredients, but are grouped here since the overall vegetable level is of primary importance to the product. The specific vegetable selection is dependent on the intended product and target flavor profile. Commercial suppliers of vegetable powders and purees have a very wide selection available. In the development of the current invention, products have been made using powders made from tomato, carrot, red pepper, mushroom and navy bean, and purees have been made from carrot, red bell pepper, spinach and tomato. Applicant notes that the invention is not limited to the aforementioned vegetables. In a preferred embodiment of the invention, dried tomato and carrot powders contribute 5.0 grams of vegetable solids and the liquid component from tomato puree and carrot juice concentrate provide 1.1 grams for a total of 6.1 grams vegetable solids or 1.0 full serving of vegetables. Overall serving size of the preferred embodiment of the product is 25.0 grams at a water activity (a_{w}) of 0.85 at room temperature (23° C.). For comparison, a small tomato of 80 grams at 94.5% moisture can provide a composition of solids of 4.4 grams.

Other wet ingredients (aside from vegetable purees and liquid vegetable concentrates) include fats, syrups and oils that help in the mixing of the dry materials and impart an effect on physical properties of the resulting product, which along with the binding agents, constitute approximately 15-30% of the formula weight, depending on the formulation. They are essential in solubilizing the vegetable powder component and improve the mouthfeel and firmness of the product. The fat blend selected in this group also adjusts the melting point of the product mixture. Major edible oils that can be used in the slice include but are not limited to Palm, Soybean, Rapeseed, Sunflower seed, Peanut, Cottonseed, Palm kernel, Coconut and Olive oils. Other oils which can be used in new embodiments of the invention, for their organoleptic or nutritional qualities, or for facilitating the manufacture of the invention, are nut oils, which include but are not limited to Almond Oil, Cashew nut oil, Pine nut oil and Walnut oil, Citrus oils, including but not limited to Grapefruit, Lemon and Orange oil, and oils from melon and gourd seeds, including but not limited to oil from the seeds of butternut squash and pumpkins.

The dry ingredients grouping includes other dry ingredients not included in the other specified groups: vegetable sources, binding or gelling agents, flavorings, preservatives. They can be sweeteners, salts, fiber containing material and other miscellaneous dry components, comprising approximately 10-15% of the formula weight, depending on the formulation. They can be used to adjust nutrient levels in the product, especially of the carbohydrate component and sodium level.

Flavorings and additives impart much of the perceived taste and smell characteristics of the product and their selection and inclusion are flexible, depending on the targeted product, in this case they comprise about 6% of the formula weight. Typical flavorings and additives include, but are not limited to, juice concentrates, cider vinegar, natural and artificial flavors and colors. In the preferred embodiment for a barbeque flavored product, the flavorings include lemon juice concentrate, cider vinegar, natural smoke flavor, BBQ seasoning, ketchup spice, and red suspension.

Binding agents, although comprising only about 0.5-15% of the formula weight, play a significant role in the resulting viscosity, hardness, density, flowability, malleability and other physical features of the product. In the preferred embodiment, gum arabic and glycerine are used, although gum combinations with locust bean gum and xanthan gum can also be used with comparable quality.

Preservatives, present at a fractional level, are essential for microbial stability. Included among preservatives are “natural preservative” such as a citrus product. Thus, although the preservative used may be a food product, or other “natural substance”, such as salt, or a citrus derivative, that is not commonly recognized as a preservative but that, in combination with the other ingredients of the invention, and with carefully controlled manufacture and distribution of the product, serves to guarantee sufficient shelf-life.

Example of a Product Formula with a Range of Weight Percentage

The ranges for each ingredient category is given below (note that ingredients can overlap in more than one category).

| | Finished | |
|---|---|---|
| | Formula | |
| | % | Sample Sources/Ingredients |
| Vegetable | 20-90% | Vegetable powders, purees, |
| Sources | | concentrates, extracts, juices. Also |
| | | whole vegetable or vegetable parts |
| | | (note formula weight includes |
| | | moisture incorporated with the |
| | | ingredient) |
| Binding | 0.5-20% | Gums, hydrocolloids and other |
| Agents | | binders and stabilizers used in making |
| | | processed foods, and include but are |
| | | not limited to Acacia, Agar, |
| | | Carrageenan, Guar, Inulin, Konjac, |
| | | Locust Bean and Tara Gum and |
| | | Pectin. Also includes liquids that |
| | | contain a binding property or interact |
| | | with other dry binding agents. |
| Flavoring | 0-10% | Solids or liquids added to impart or |
| Agents | | enhance sensory appeal of product |
| Other Dry | 0-20% | Sweeteners, salts, fibers, thickeners |
| Ingredients | | and miscellaneous dry ingredients |
| Other Wet | 0-30% | Water, oils and fats, concentrates, |
| Ingredients | | syrups and other miscellaneous liquid |
| | | ingredients |
| Preservatives | 0-1% | Components added to inhibit spoilage |
| | | and extend shelf-life, may include |
| | | antimicrobials (e.g. sorbates, sulfites, |
| | | benzoates, nitrates, nitrites, |
| | | propionates, lactic acid) and |
| | | antioxidants (e.g. ascorbates, sulfites, |
| | | tocopherols). |

In an embodiment, the nutritionals of about 25 gram product serving would provide the following: 63 calories, 0.8 grams protein, 2.7 grams fat (0.9 grams saturated). 8.7 g carbohydrate (2.5 grams fiber, 4.9 g sugar), and 121 mg of sodium.

In an embodiment for making the product slice at a lab scale, note that no customized equipment or unconventional processing is required. Further, note that extreme thermal conditions or excessive mechanical actions on the material are avoided to minimize nutrient loss. All of these processing steps are easily scalable for large-scale manufacturing process. In the preferred embodiment of the invention, the processing steps are as follows:
1. Weigh out glycerine & gum arabic and mix them together;
2. Weigh all other dry ingredients except vegetable powders, seasonings and dry flavors; add them to glycerine & gum mixture and mix well;
3. Heat mixture to between about 170 F to 200 F, more preferably 180 F to 190 F, and most preferably 185 F;
4. Weigh out and add vegetable powders to heated slurry;
5. Spread mass between pieces of parchment paper and roll out to a thickness between about 2 mm to about 6 mm, and most preferably about 3 mm thickness;
6. Weigh seasonings and dry flavors and sprinkle on rolled out dough;
7. Cut into about 16 g to about 34 g, more preferably about 20 g to about 30 g, and most preferably 25 g slices (3½″ diameter, most preferably 3 mm thick, using a circle cookie cutter). No limitation is placed on the shape. Shapes can include geometric shapes, abstract shapes and figure shapes of people, animals, or inanimate objects.
   Product Formula Constituents with a Range of Weight Percentage

The ranges for each ingredient category are given below (note that ingredients can overlap in more than one category). A specific example is given below for a product that has demonstrably easy to use and pleasing organoleptic qualities. Pleasing organoleptic properties in this embodiment include, but are not limited to, improved mouthfeel, as described elsewhere in the application, and especially through increased smoothness and reduced grittiness, the appealing color and aroma of the slices and the popularly liked flavors of Catsup and BBQ. This is a possible formula, but not the only one—others could be very different depending on the intended product attributes.

| | | Finished | Finished |
|---|---|---|---|
| | | Formula | Serving |
| | Ingredient Description | % | g |
| Vegetable | Dried Tomato Powder | 10.02% | 2.50 |
| Sources | Dried Carrot Powder | 12.02% | 3.00 |
| | Tomato Puree | 31.54% | 7.87 |
| | Carrot Juice Concentrate | 1.16% | 0.29 |
| Binding | Gum Arabic | 0.50% | 0.13 |
| Agents | Glycerine, 99.7% USP | 13.55% | 3.38 |
| Flavoring | Lemon Juice Concentrate | 0.60% | 0.15 |
| Agents | Cider Vinegar 50 grain | 3.61% | 0.90 |
| | BBQ Seasoning | 1.20% | 0.30 |
| | Catsup Spice | 0.06% | 0.02 |
| | Red Suspension AF | 0.20% | 0.05 |
| Other Dry | Salt | 1.00% | 0.25 |
| Ingredients | Inulin | 5.73% | 1.43 |
| | Sugar | 4.85% | 1.21 |
| Other Wet | Tapioca Syrup 45 DE | 3.85% | 0.96 |
| Ingredients | Palm oil, sans trans fats | 4.81% | 1.20 |
| | Olive Oil | 5.21% | 1.30 |
| Preservatives | Potassium sorbate | 0.08% | 0.02 |
| | Total | 100.00% | 25.00 |

### Calculation of Vegetable or Fruit Servings

For instance, the USDA sets a serving size for vegetables to be equal to about one-half cup, except for greens like spinach and lettuce, which have a serving size equal to one full cup. One serving of sliced fruit or berries is equal to one-half cup; however a single piece of fruit, such as an apple or an orange counts as one serving. The USDA chose one-half cup as a serving size based on the portion sizes that people typically eat, ease of use, and the nutritional content of fruits and vegetables.

Nutrition and dietary experts suggest you eat from five to nine servings of fruits and vegetables every day. Older or inactive women and smaller children need at least three servings of vegetables and two servings of fruit. Growing kids, teen girls, most men and active women should eat at least four servings of vegetables and three servings of fruit every day. Teen boys and active men should eat at least five servings of vegetables and four servings of fruit every day. Unfortunately, many people fail to eat even the minimum suggested level of five servings of fruits or vegetables each day.

Vegetable servings of each vegetable source were calculated as follows:

USDA serving weight¹ (g)×% solids in USDA source²=grams of solids in USDA serving

¹ Economic Research Service/USDA A Dietary Assessment of the U.S. Food Supply/AER-772, USDA ARS, October 1997, pp 40-41.² USDA Agriculture Research Service, National Agriculture Library, USDA National Nutrient Database for Standard Reference

Grams of solids in USDA serving±% solids in source used in formula=g of source to equal one serving vegetables

Each slice is formulated to contain the equivalent of one serving of vegetables. Servings refer to the amount of vegetable solids contained in a serving of a fresh vegetable as defined by the US Department of Agriculture (USDA). The USDA specifies the weight of fresh vegetables of many types that constitute a serving. The vegetable solids are what remains after the water has been extracted from the vegetables.

Vegetable powders, purees, concentrates, juices and other forms of processed whole vegetables (collectively referred to as “vegetable sources”) contain different amounts of solids per weight of product. The slice is formulated such that the vegetable sources in one slice contain at least the amount of vegetable solids in one serving of fresh vegetables as specified by the USDA.

### Serving Sizes for Selected Vegetables Based on USDA Reference Amounts

Approximate serving size of some sample vegetables in grams is noted below for the calculation of the required amount of vegetable sources.

| | USDA^{3,4} | |
|---|---|---|
| Vegetable | Serving Size (g) | Reference Amount |
| Bell Peppers | 61 | ½ cup, raw |
| Broccoli | 44 | ½ cup, raw |
| Carrots | 62 | ½ cup, raw |
| Leaf Lettuce | 56 | 1 cup raw |
| Tomatoes | 90 | ½ cup, raw |
| Spinach | 30 | 1 cup raw |
| Legumes | 37 | dry weight of ½ cup, |
| | | cooked, drained |

³The Food Guide Pyramid bulletin Food Choices Chart and other USDA dietary guidance materials (USDA, CNPP, 1996; USDA, March 1997) was defined for each food supply commodity, using serving weights identified in the USDA Nutrient Data Base (NDB) (USDA, ARS, October 1997).
⁴Cross reference these values with the USDA Agricultural Research Service, National Agricultural Library.
http://ndb.nal.usda.gov/.

The initial embodiment is a convenient form of a foodstuff typically for a consumer who is reluctant to include a significant quantity of vegetables to his overall diet. The following embodiments would provide additional, specific nutritional benefits in addition the overall general benefits sought when eating vegetables.

In another embodiment, the slice would be formulated for those persons desiring a high nutrient and high protein food (for example gymnasts and bodybuilders) and would include those vegetables with high protein content such as those from the Fabaceae/Leguminosae genus and the Ipomea genus.

In a different embodiment the slice would be formulated to benefit expectant or lactating mothers, by adding such vegetables as the Fabaceae/Leguminosae genus vegetables and the grains and cereals of the Zizinia, Oryza, Zea, Avena, Triticum, Secale, Hordeum, Sorghum, Fagopyrum, Digitaria, Amaranthus and Chenopodum genera.

Another embodiment would include those vegetables generally accepted to assist bowel movement, such as the Fabaceae/Leguminosae genus vegetables and the Ipomea genus vegetables, with particular attention to the inclusion of vegetables with a high fiber content.

Another embodiment would include those vegetables known to contain high concentrations of the B-Complex vitamins, such as the grains and cereals, Potatoes, Legumes and Chili Peppers mentioned herein

Another embodiment would include cranberry, or other fruits and berries from the Ericaceae family, or apple or other fruit from the Rosaceae family, to make a slice that delivered a full serving of fruit and would be an appealing way to include a serving of fruit in a sandwich, for example a turkey sandwich.

In another embodiment the formulations and slurries described in this application would be packed in cartridges or such containers for use in machines and other contrivances for 3D Printing and Additive Manufacturing, adhering to the specifications required by these machines for the provision of consumable materials. The entire formulation could be within one container, or different parts of it could be in different containers so that the electronic data source could modify the slice product, as desired by the consumer. In another embodiment, the vegetable (or fruit) sources, binding agents, other wet and dry ingredients and preservatives are included in one container and the flavoring agents in another. As described elsewhere in this application, the flavorings could include, but are not limited to BBQ, Ketchup, Relish or Teriyaki, and the desired flavoring could be chosen prior to making the slice. In another embodiment, an additional container could include nutritional components, such as vitamins or other nutrients to be infused into the mixture or slurry, and the electronic data source would control the appropriate proportions of the contents of the different containers to be deposited to make the slice product, as desired.

In another embodiment, the formulations and slurries described in this application, and following weighing, mixing, spreading or forming or cutting processes also described in this application, would be baked, fried or toasted, giving the product the satisfying organoleptic property of a “crisp” or “crunchy” texture. In another embodiment, this crisp product would be sliced, broken, ground or crumbled into smaller pieces, crumbs or granules, for the use of, by example but not limited to, adding the product onto a burger, salad, or onto soup, as in the form of a crouton.

Although the invention has been explained with respect to an embodiment, it is to be understood that many other possible modifications and variations can be made without departing from the spirit and scope of the invention as herein described.

An embodiment of the current invention is a method of making a vegetable-based foodstuff comprising portioning all of the ingredient components by weight or volume, solubilizing binding agents either alone or with other suitable ingredients of the formula. This step may also be done simultaneously with the following step of mixing of all other non-vegetable ingredients, except any ingredient applied after the bulk of the product is made (e.g., dry ingredient sprinkled on or liquid glaze applied to the outside of finished product). The mixture is heated to facilitate forming a uniform slurry. Ingredients will vary based on the formula of the product. The embodiment further comprises the step of adding to the slurry all vegetable-derived ingredients, selected from vegetable powders, purees, concentrates, juices, whole or partial fresh vegetables and combinations thereof. Although better control is achieved with this being a separate step, this mixing could be performed simultaneously with the previous step. The next step includes cooling of the slurry to a shapeable dough at a temperature to facilitate shaping and portioning. This is usually at room temperature, but could be higher or lower temperature if the dough is suitably shapeable. The following step is shaping includes spreading/rolling of the dough to form a desired shape (e.g., flat-sheet or sliceable loaf), then cutting the shaped dough to desired slices or other shapes. Afterwards, the step comprises applying the desired amount of dry or liquid ingredient (e.g. flavorings) onto the product surface (may also be performed prior to the final slicing). Finally, the method involves packaging the product appropriate to desired usage, including single or bulk use; examples include, but are not limited to, in a bag, in plastic film or wax paper, in a pouch, tub or box, in a cardboard sleeve or using a combination of the aforementioned packages or other type of package, as appropriate.

Alternative and variant manufacturing methods includes the utilization of a variety of equipment can be used to accomplish the above methodology. As mentioned, steps may be combined and do not have to be performed strictly in the listed order as long as a uniform shapeable dough can be formed. Possible alternatives also include the following: (1) spreading the slurry to create a sheet of dough/paste on a platform or moving conveyor belt by depositing the slurry at a desired thickness by: (a) extrusion under pressure through a flat nozzle with controlled slit-thickness; (b) compression through twin-rollers with a controlled gap-thickness; or (c) compression with a flat press with a controlled charge-weight and pressure; and (2) alternatively, the slurry may be poured, injected, pumped or sprayed into shaping molds (before or after the cooling step) to impart a desired shape to the product. Suitable shapes include a cylindrical, loaf or other shape and then sliced, using a mechanical or manual cutter.

Another embodiment of the current invention is a method of making a vegetable-based foodstuff includes weighing an amount of a binding agent, mixing the amount of the binding agent into a mixture, weighing an amount of other ingredients, mixing an amount of other ingredients into the mixture, heating the mixture into a slurry, weighing an amount of a vegetable-derived composition, adding the amount of vegetable-derived composition to the heated slurry, cooling the slurry to room temperature, spreading the slurry on a platform, rolling the slurry into a dough, weighing an amount of dry flavor seasoning, sprinkling the amount of dry flavor seasoning onto the dough, and cutting the dough into a slice. The vegetable-derived composition is in a form selected from the list consisting of powders, purees, concentrates, juices, and a combination thereof. An alternative embodiment is the same as above except instead of vegetable-derived composition, a fruit-derived composition is added or a combination of vegetable-derived composition and fruit-derived composition.

The binding agent is selected from the list consisting of a glycerine, a gum Arabic (also known as Acacia Gum), and a combination thereof. The other ingredient is selected from the list consisting of dry ingredient, preservative, wet ingredient, and a combination there of The dry ingredient is selected from the list consisting of salt, inulin, sugar, non-sugar sweetener, carbohydrate, and a combination there of The preservative is potassium sorbate. The wet ingredient is selected from the list consisting of fats, syrup, oil, and a combination thereof The oil is selected from the list consisting of palm oil, olive oil, and a combination thereof The syrup is Tapioca Syrup 45 DE.

The method of making a vegetable-based foodstuff includes heating the mixture is between about 175 F to about 195 F., specifically, the heating of the mixture is at about 185 F. The heating the mixture is with constant stirring until the slurry is achieved. The room temperature is from about 62 F to about 82 F. The platform is a parchment paper. The dough is rolled into a thickness of about 3 mm. The dough is cut into a slice having a geometric shape. The geometric shape is selected from the list consisting of a circle, an oval, a triangle, a square, a rectangle, a trapezoid, a pentagon, a hexagon, a heptagon, an octagon, a nonagon, a decagon, and a combination thereof.

Another embodiment of the current invention is a fabricated, vegetable-based slice comprising a vegetable source (or a fruit source or a combination thereof), a dry ingredient, a preservative, a binding agent, and a wet ingredient. The fabricated, vegetable-based slice further comprises a flavoring agent. The vegetable source is of a form consisting of a list selected from powders, purees, and a combination thereof.

### Vegetable Sources

Embodiments can comprise the following commercially available vegetable powders: beet, black olive, broccoli, cabbage, carrot, celery, cucumber, garlic, green collard, kale, mushroom, navy bean, pea, red pepper, spinach, sweet potato, sweet corn, tomato, white onion, and zucchini. The previous list is not limiting.

Embodiments can comprise the following commercially available vegetable purees: artichoke, asparagus, bell pepper (green, red, and yellow), broccoli, Brussels sprout, butternut squash, carrot, carrot (yellow), cauliflower, celery, corn (jubilee and super sweet), edamame, eggplant, fennel, garlic, ginger, green bean, green onion, leek, onion (red and yellow), pea, pea (sugar snap), pepper (Anaheim green and red, Habanero, Jalapeno, green and red, Poblano, Serrano), shallot, spinach, squash (summer, yellow), tomatillo, tomato (Roma and round), zucchini (there may be others). The list is not limiting.

Other types of vegetables that can be added include vegetables of the Brassica genus, including but not limited to roots (including but not limited to Rutabaga and Turnips), stems (including but not limited to Kohlrabi), leaves (including but not limited to Cabbage, Collard Greens and Kale), flowers (including but not limited to Cauliflower and Broccoli), buds (including but not limited to Brussel Sprouts and Cabbage), and seeds (including but not limited to, Mustard seed and oil-producing Rapeseed). The list is not limiting.

Another embodiment includes recombinant vegetable proteins or molecules, including the aforementioned lists of proteins and molecules without being limiting made from bacteria, yeast or other microbes.

The fabricated, vegetable-based slice includes a vegetable source selected from the list consisting of tomato, carrot, pepper, mushroom, bean, spinach, grains, cereals, potatoes, legumes, chili peppers, beet, olive, broccoli, cabbage, celery, cucumber, garlic, green collard, kale, mushroom, pea, sweet potato, corn, onion, zucchini, artichoke, asparagus, bell pepper (green, red, and yellow), broccoli, Brussels sprout, butternut squash, cauliflower, corn, edamame, eggplant, fennel, garlic, ginger, green bean, green onion, leek, onion (red and yellow), pea, pea (sugar snap), pepper (Anaheim green and red, Habanero, Jalapeno, green and red, Poblano, Serrano, chili, Bell, Red, Yellow, Jalapefio, Banana, Cayenne, Pepperoncini, Paprika, and Pimiento), shallot, squash (summer, yellow), tomatillo, rutabaga, turnip, kohlrabi, mustard seed, rapeseed, chives, scallion, leek, coriander, parsley, basil, mint, rosemary, sage, savory, marjoram, oregano, hyssop, thyme, lavender, perilla, chia, Chayote, yam, celeriac, gherkin, lettuce, black-eyed pea, garbanzo bean, lima bean, pinto bean, kidney bean, millet, triticale, wild rice, rice, maize, oats, wheat, rye, barley, sorghum, buckwheat, fonio, quinoa, spelt, Einkorn Wheat, durum, kamut, amaranth, emmer, radish, squash, pumpkin, gourd, winter squash, summer squash, vegetable marrow, courgette, acorn squash, beetroot, chard, sugar beet, artichoke, okra, truffle, and a combination thereof.

The fabricated, vegetable-based slice includes a vegetable source selected from the genera or families consisting of Fabaceae/Leguminosae, Ipomea, Zizinia, Oryza, Zea, Avena, Triticum, Secale, Hordeum, Sorghum, Fagopyrum, Digitaria, Amaranthus, Chenopodum, Brassica, Allium, Daucus, Solanum, Coriandrum, Petroselinum, Manihot Glycine, Lamiaceae, Sechium, Dioscorea, Apium, Cucumis, Lactuca, Asparagus, Rahpanus, Cucurbita, Beta, Cynara, Abelmoschus, Capsicum, Fungi, and a combination thereof.

The vegetable source and/or fruit source has a percentage weight between about 20% to about 90%, preferably between about 55% to about 60%. Other dry ingredient has a percentage weight between about 0 to about 15%, preferably between about 10% to about 15%. The preservative has a percent weight between about 0% to about 1%. The binding agent has a percent weight between about 0.5% to about 15%. The flavoring agent has a percent weight between about 0% to about 10%. Other wet ingredient has a percent weight between about 0% to about 30%, preferably between about 15% to about 30%.

### Fruit Sources

Fruits include berries among other items.

Commonly available fruit powders include, but are not limited to powdered Acai, Acerola, Apple, Blackberry, Cranberry, Mango, Grapefruit, Lemon, Orange, Raspberry and Strawberry.

Embodiments can comprise fruits of the Actinidiaceae family, including, but not limited to Kiwi fruit.

Embodiments can comprise fruits of the Adoxaceae family, including, but not limited to Elderberry.

Embodiments can comprise fruits of the Anacardiaceae family, including, but not limited to Mangoes.

Embodiments can comprise fruits of the Annonaceae family, including but not limited to Soursop, Custard Apple, Pawpaw and Guanabana.

Embodiments can comprise fruits of the Arecaceae family, including, but not limited to Coconut and Date.

Embodiments can comprise fruits of the Bromeliaceae family, including, but not limited to Pineapple.

Embodiments can comprise fruits of the Cactaceae family, including, but not limited to Dragon Fruit, Pitahaya and Prickly Pear.

Embodiments can comprise fruits of the Capparaceae family, including, but not limited to Hanza.

Embodiments can comprise fruits of the Caricaceae family, including, but not limited to Papaya.

Embodiments can comprise fruits of the Chrysobalanaceae family, including, but not limited to Licania.

Embodiments can comprise fruits of the Clusiaceae family, including, but not limited to Monkey Fruit and Mangosteen.

Embodiments can comprise fruits of the Cucurbitaceae family, including, but not limited to Cantaloupe and Watermelon.

Embodiments can comprise fruits of the Ebenaceae family, including, but not limited to Black Sapote and Persimmon.

Embodiments can comprise fruits of the Ericaceae family, including, but not limited to Cranberry, Blueberry, Bilberry and Bearberry.

Embodiments can comprise fruits of the Fabaceae family, including, but not limited to Tamarind.

Embodiments can comprise fruits of the Grossulariaceae family, including, but not limited to Gooseberry and Red Currant.

Embodiments can comprise fruits of the Lauraceae family, including, but not limited to Avocados (also considered to be vegetables).

Embodiments can comprise fruits of the lythraceae family, including, but not limited to Pomegranate.

Embodiments can comprise fruits of the Moraceae family, including, but not limited to Fig, Breadfruit and Mulberry.

Embodiments can comprise fruits of the Musaceae family, including, but not limited to Bananas and Plantains.

Embodiments can comprise fruits of the Myrtaceae family, including, but not limited to Guava and Wax Apple.

Embodiments can comprise fruits of the Orchidaceae family, including, but not limited to Vanilla.

Embodiments can comprise fruits of the Oxalidaceae family, including but not limited to Carambola and Starfruit.

Embodiments can comprise fruits of the Passifloraceae family, including, but not limited to Passion Fruit and Granadilla.

Embodiments can comprise fruits of the Polygonaceae family, including, but not limited to Rhubarb.

Embodiments can comprise fruits of the Rhamnaceae family, including, but not limited to Jujube.

Embodiments can comprise fruits of the Rosaceae family, including, but not limited to Apples, Apricots, Cherries, Nectarines, Peaches, Pears, Plums, Prunes, Quince, Raspberries and Strawberries.

Embodiments can comprise fruits of the Rubiaceae family, including but not limited to the Spanish Tamarind.

Embodiments can comprise fruits of the Rutaceae family, including, but not limited to Grapefruit, Lemons, Limes, Oranges, Kumquats and Tangerines.

Embodiments can comprise fruits of the Sapindaceae family, including, but not limited to Lychee and Guarana.

Embodiments can comprise fruits of the Sapotaceae family, including, but not limited to Mamey and Miracle Fruit.

Embodiments can comprise fruits of the Solanaceae family, including, but not limited to Naranjilla.

Embodiments can comprise fruits of the Vitaceae family, including, but not limited to Grapes.

### Binding Agents

The binding agent is selected from the list consisting of a glycerine, a gum arabic, and a combination thereof. Gums, hydrocolloids and other binders and stabilizers used in making processed foods, and include but are not limited to Acacia, Agar, Carrageenan, Guar, Inulin, Konjac, Locust Bean and Tara Gum and Pectin. Also included are liquids that contain a binding property or interact with other dry binding agents.

### Other Dry Ingredients

The dry ingredient for the above embodiment is selected from the list consisting of salt, inulin, sugar, non-sugar sweetener, carbohydrate, and a combination there of. Sweeteners, salts, fibers, thickeners and miscellaneous dry ingredients are included.

### Preservatives

The preservative is potassium sorbate. Preservatives include components added to inhibit spoilage and extend shelf-life, may include antimicrobials (e.g. sorbates, sulfites, benzoates, nitrates, nitrites, propionates, lactic acid) and antioxidants (e.g. ascorbates, sulfites, to copherols).

### Other Wet Ingredients

The wet ingredient is selected from the list consisting of fats, syrup, oil, and a combination thereof. The oil is selected from the list consisting of palm oil, olive oil, and a combination thereof. The syrup is Tapioca Syrup 45 DE. Water, oils and fats, concentrates, syrups and other miscellaneous liquid ingredients are included as other wet ingredients.

Although the invention has been explained with respect to an embodiment, it is to be understood that many other possible modifications and variations can be made without departing from the spirit and scope of the invention as herein described.

Further, in general with regard to the processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

Moreover, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

Lastly, all defined terms used in the application are intended to be given their broadest reasonable constructions consistent with the definitions provided herein. All undefined terms used in the claims are intended to be given their broadest reasonable constructions consistent with their ordinary meanings as understood by those skilled in the art unless an explicit indication to the contrary is made herein. In particular, use of the singular articles such as “a,” “the,” “said,” etc. should be read to recite one or more of the indicated elements unless a claim recites an explicit limitation to the contrary.

1. A method of making a vegetable-based foodstuff comprising:
weighing an amount of a vegetable-derived composition.

2. A method of making a fruit-based foodstuff comprising:
weighing an amount of a fruit-derived composition.

3. A fabricated, vegetable-based slice comprising a vegetable source.

4. A fabricated, fruit-based slice comprising a fruit source.

5. A fabricated slurry or mixture comprising a weighed amount of a vegetable composition or a fruit composition or a combination thereof in a container for use in “3D Printing” or “Additive Manufacturing” machines to make the foodstuff in various forms.

6. A method of making foodstuff in a 3D configuration comprising:
applying a vegetable composition or a fruit composition or a combination thereof to a 3D Printing process or Additive Manufacturing process.
